(19) United States
(12) Patent Application Publication
(10) Pub. No.: US 2025/0342259 A1
(43) Pub. Date: Nov. 6, 2025

(54) SELECTIVE DATA MANAGEMENT ON VERIFIABLE PERSISTENT DATA STRUCTURES

(71) Applicant: TRAENT S.R.L., Milano (IT)

(72) Inventors: Andrea Canciani, Via delle Medaglie d'oro 13, PISA (IT); Claudio Felicioli, Via Giuseppe Cesare Abba 4, PISA (IT); Fabio Severino, Piazza Cairoli 3, PISA (IT)

(73) Assignee: TRAENT S.R.L., Milano (IT)

(21) Appl. No.: 18/869,548

(22) PCT Filed: May 29, 2023
(86) PCT No.: PCT/EP2023/064316

§ 371 Date: Nov. 26, 2024

(30) Foreign Application Priority Data
May 30, 2022 (IT) 102022000011360

(51) Int. Cl. G06F 21/60; G06F 21/62; H04L 9/08

(52) U.S. Cl. CPC G06F 21/602; G06F 21/62; H04L 9/0891

(57) ABSTRACT

A solution is proposed for storing data in the form of one or more fields each one comprising a respective field identifier and a respective field value. The solution comprises, for each one of said one or more fields, storing the field identifier and a first value of the field value by storing (410) an indication of the first value in a non-persistent data structure (110), and appending (420) a first data block to a persistent data structure (115). The first data block comprises the field identifier and a digest of the indication of the first value. The solution comprises, for each one of said one or more fields, updating the field value from the first value to a second value by storing (430) an indication of the second value in the non-persistent data structure, and appending (445; 470) a second data block to the persistent data structure. The second data block comprises the field identifier and a digest of the indication of the second value.

### TECHNICAL FIELD

The present disclosure relates to the information technology field. Particularly, this disclosure relates to the storing of data. More particularly, the present disclosure relates to distributed ledger technology.

### BACKGROUND

The background of the present disclosure is hereinafter introduced with the discussion of techniques relating to its context. However, even when this discussion refers to documents, acts, artifacts and the like, it does not suggest or represent that the discussed techniques are part of the prior art or are common general knowledge in the field relevant to the present disclosure.

Storing of data is a commonplace activity in most computing systems (for example, for their preservation, outputting, and/or further processing). In several situations, the storing of data is subject to specific requirements.

Particularly, it may be required that the storing of the data is persistent; this means that it should not be possible to remove the data once they have been stored; therefore, any updates of the data should preserve all previous versions of the same data. For this purpose, it may be important to ensure integrity of the data being stored.

Distributed ledger technology (DLT) is a technology used to maintain a distributed ledger, i.e., a replicated, shared, and synchronized collection of digital records spread across multiple computer nodes (also referred to as “participant nodes” or simply “nodes”) typically located across multiple sites, countries, or institutions.

Unlike a traditional database, a conventional distributed ledger has no central data store or administration functionality.

Particularly, a conventional distributed ledger eliminates the need for a single central authority to maintain the integrity of the data stored in the ledger: instead, this task becomes the responsibility of the participant nodes, based on a proper consensus schema.

All information in the ledger typically uses cryptography techniques to ensure consistency, integrity, security and permissions using cryptographic keys, encryption and digital signatures. Once data is committed and stored in the ledger it is considered as an immutable entry in the database of records which is governed by the rules of the consensus schema.

A conventional distributed ledger stores data into a sequence of data blocks in chronological order, linked to each other via corresponding hash values (or digests). The ledger is distributed throughout the participant nodes, which validate its content according to the consensus schema. In a consensus schema based on a proof of work, a complex mathematical problem has to be solved by determining a nonce to be added to each data block that provides a specific property of its hash value. Therefore, no data block may be altered without re-determining the nonces of such data block and of all the next data blocks in the ledger; however, the difficulty of the mathematical problem required to determine the nonces makes substantially impossible to alter the distributed ledger (unless a majority of the processing power of the whole network is acquired).

### PROBLEM DESCRIPTION

Cryptographic hashes and signatures are very effective to verify that the underlying data has not been tampered with, but they do not directly support controlled forms of data modification, such as data removal.

Nonetheless, with the increasing number of DLT applications, which may include sensitive information, features to redact or correct or remove data might represent an important or strict requirement, and may be even legally obliged in order to comply with privacy-related regulations.

For example, the general data protection regulation (GDPR) of the European Union imposes the right to be forgotten as a key data subject right.

In light of this regulation, it is no longer legally possible to use persistent data structure (such as DLT ledgers) in processes where personal data are recorded. Indeed, in DLT ledgers data removal is hard or impossible, because of the properties of the ledger itself.

This invention is aimed at enabling selective data management (such as, update, removal and disclosure) in the context of persistent data structure (such as DLT ledgers), while preserving cryptographic verifiability.

### SUMMARY

A simplified summary of the present disclosure is herein presented in order to provide a basic understanding thereof; however, the sole purpose of this summary is to introduce some concepts of the disclosure in a simplified form as a prelude to its following more detailed description, and it is not to be interpreted as an identification of its key elements nor as a delineation of its scope.

In its general terms, the present disclosure is based on the idea of storing data by storing removable data portions in a non-persistent data structure, and by appending non-removable data portions including digests of the removable data portions to a persistent data structure.

Particularly, an aspect provides a method for storing data in the form of one or more fields each one comprising a respective field value. The method comprises, for each field, storing an indication of a first value of the field value in a non-persistent data structure, and appending a first data block including a digest of the indication of the first value to a persistent data structure, and updating the field value by storing an indication of a second value in the non-persistent data structure, and appending a second data block including a digest of the indication of the second value to the persistent data structure.

Another aspect provides a software program (or computer program) for implementing the method.

A further aspect provides a corresponding software program product (or computer program product).

A further aspect provides a computing system for implementing the method.

A further aspect provides a system comprising one or more of said computing systems.

More specifically, one or more aspects of the present disclosure are set out in the independent claims and advantageous features thereof are set out in the dependent claims, with the wording of all the claims that is herein incorporated verbatim by reference (with any advantageous feature provided with reference to any specific aspect that applies mutatis mutandis to every other aspect).

### BRIEF DESCRIPTION OF THE DRAWINGS

The solution according to embodiments of the present disclosure, as well as further features and the advantages thereof, will be best understood with reference to the following detailed description thereof, given purely by way of a non-restrictive indication, to be read in conjunction with the accompanying drawings (wherein, for the sake of simplicity, corresponding elements are denoted with equal or similar references and their explanation is not repeated, and the name of each entity is generally used to denote both its type and its attributes, like value, content and representation). Particularly:

FIG. 1A and FIG. 1B show the general principles of the solution according to embodiments of the present disclosure;

FIG. 2 shows a schematic block diagram of an information technology infrastructure that may be used to implement the solution according to embodiments of the present disclosure;

FIG. 3 shows the main software components that may be used to implement the solution according to embodiments of the present disclosure, and

FIG. 4 shows an activity diagram describing the flow of activities relating to an implementation of the solution according to embodiments of the present disclosure.

### DETAILED DESCRIPTION

In the following, when one or more features are introduced by the wording “according to an embodiment”, they are to be construed as features additional or alternative to any features previously introduced, unless otherwise indicated and/or unless there is evident incompatibility among feature combinations.

In the following, only relevant features that are deemed pertinent for the understanding of the present disclosure will be discussed, with well-known and/or obvious variants of the relevant features that will be omitted for the sake of conciseness.

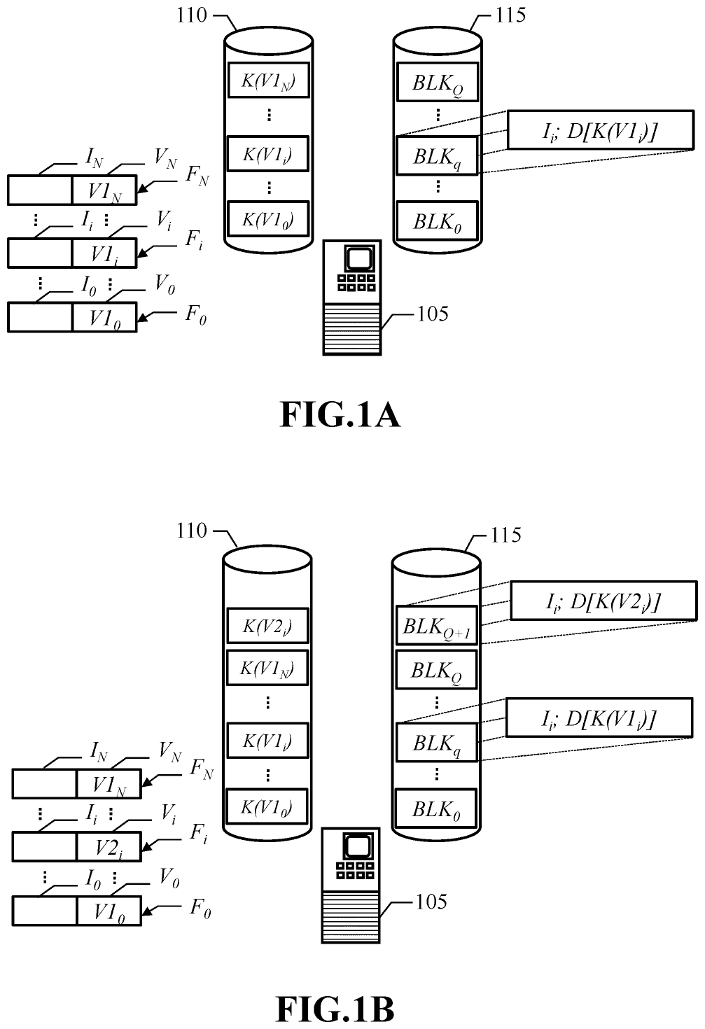

With reference to FIG. 1A and FIG. 1B, they show the general principles of the solution according to embodiments of the present disclosure.

Starting from FIG. 1A, one or more storage nodes 105 (only one shown in the figure) store data.

According to an embodiment, the data may comprise structured or semi-structured data (hereinafter, also referred to as composite object).

For the purposes of the present disclosure, the structured data comprise data that adhere to a pre-defined data model (i.e., a model of how data can be stored, processed and accessed). Examples of structured data include, but are not limited to, Excel files or SQL databases.

For the purposes of the present disclosure, the semi-structured data are a form of structured data that do not conform with the formal structure of data models associated with relational databases or other forms of data tables, but nonetheless contain tags or other markers to separate semantic elements and enforce hierarchies of records and fields within the data. Examples of semi-structured data include, but are not limited to, JSON data and XML data.

For the purposes of the present disclosure, the (structured or semi-structured) data (or composite object) is in the form of one or more fields Fᵢ (i=0, 1, . . . N) each one comprising a respective field identifier Iᵢ and a respective field value Vᵢ (i.e., the field value Vᵢ is associated with the field identifier Iᵢ).

For the purposes of the present disclosure, the field identifier Iᵢ represents a fixed component of the respective field Fᵢ (such as an attribute or property or feature thereof).

For the purposes of the present disclosure, the field value Vᵢ represents a variable or updatable component of the respective field Fᵢ. In alternative embodiments, discussed in the following, the field identifier Iᵢ may also represent a variable component of the respective field Fᵢ. Just as an example, the field value Vᵢ may be a textual value and/or numerical value. Just as another example, the field value Vᵢ may be a (e.g., textual and/or numerical) value among a plurality of accepted values.

According to an embodiment, for each field Fᵢ, the storage node 105 stores the respective value of the field value Vᵢ (in association with the field identifier Iᵢ).

According to an alternative (herein considered) embodiment, for each field Fᵢ, the storage node 105 stores an indication (e.g., an encrypted version) of the respective value (hereinafter value indication). In the following, whenever the value indication is cited, it is intended that the associated feature equivalently applies in embodiments in which the value instead of the value indication is stored.

In the illustrated example, V1ᵢ denotes a (current) value of the field value Vᵢ of each field Fᵢ, and K(V1ᵢ) denotes the respective value indication. In the illustrated example, V1₀ and K(V1₀) respectively denote the (current) value of the field value V₀ of the field F₀ and the corresponding value indication, whereas V1_{N} and K(V1_{N}) respectively denote the (current) value of the field value V_{N} of the field F_{N} and the corresponding value indication.

According to an embodiment, for each field Fᵢ, the storage node 105 stores the respective value indication K(V1ᵢ) in a repository (hereinafter, value repository) 110.

For the purposes of the present disclosure, the value repository 110 comprises a non-persistent data structure, such as a conventional database (or more thereof), supporting data removal. According to an embodiment, the non-persistent data structure comprises a private non-persistent data structure (e.g., a database whose management is essentially restricted to the storage node 105). As better discussed in the following, storing the value (or the value indication) in a value repository supporting data removal allows selectively removing specific values (or specific value indications) from the value repository 110, for example for selective disclosure purposes.

According to an embodiment, for each field (of for each group of fields, as better discussed in the following) the storage node 105 appends a corresponding data block BLK_{q} (q=0, 1, . . . Q) to a persistent data structure (such as a ledger) 115. Without losing generality, the persistent data structure may comprise a tamper-proof data structure.

By tamper-proof data structure it is herein meant a data structure configured to make practically unfeasible altering its stored content. This means that an altering of the stored content would require an effort higher than an importance thereof. Therefore, even if someone with enough resources (such as available time, computational power, skill, knowledge and/or instruments) might potentially manage to alter the stored content, the need to resort to these extreme measures (and a possible uncertainty of the obtained results) is a significant deterrent in practical circumstances; this frustrates any attempt of altering the stored content down to deter everybody from attempting it, thereby effectively preventing doing so.

According to an embodiment, the persistent data structure comprises a private persistent data structure (e.g., a persistent data structure whose management is essentially restricted to the storage node 105).

According to an embodiment, the ledger 115 (for example, a private ledger) may be based on “Distributed Ledger Technology” (DLT).

Considering, just as an example, the field Fᵢ, the corresponding data block (for example, the data block BLK_{q}) comprises the field identifier Iᵢ and a digest of the value indication K(V1ᵢ) (hereinafter referred to as digest D[K(V1ᵢ)]).

According to an embodiment, the digest (or hash value) is computed by applying a cryptographic hash function to the value indication K(V1ᵢ). The cryptographic hash function is a hash function that maps data of arbitrary size to values of fixed-size. The cryptographic hash function is deterministic (i.e., it always produces the same digest for the same input value), and non-invertible (i.e., with the digest that may be calculated from the input value in a relatively fast way but with the input value that is practically infeasible to be calculated from the digest).

According to an embodiment, the data blocks BLK_{q} are arranged in (chronological) sequence defined by their appending to the ledger 115 (from BLK₀ to BLK_{Q} in the example at issue). For this purpose, the data blocks BLK_{q} may only be added in sequence by appending them to an end of the ledger 115. Therefore, the ledger 115 accumulates the data that are never removed from the ledger 115 once they have been added therein (with any updates of the data that preserve all previous versions of the same data).

According to an embodiment, the value repository 110 and the ledger 115 may be physically located or reside in a same storage node 105 (as exemplary illustrated) or in different storage nodes (or in different processing entities other than the storage nodes).

According to an embodiment, the value repository 110 and the ledger 115 are separate from each other. By value repository 110 and ledger 115 separate from each other, it is herein meant that the value repository 110 and the ledger 115 may be accessed in an independent way with respect to each other, regardless of their actual physical location (i.e., regardless they are physically located or reside in a same storage node 105, in different storage nodes or in different processing entities).

Moving to FIG. 1B, the storage node 105 updates the field value Vᵢ of the i-th field Fᵢ from the value V1ᵢ to value V2ᵢ (for example, in response to an updating request).

According to an embodiment, for the i-th field Fᵢ, the storage node 105 stores, in the value repository 110, a value indication K(V2ᵢ) in association with the field identifier Iᵢ, and appends a data block BLK_{Q+1} to the ledger 115 (at an end of its sequence) comprising the field identifier Iᵢ and a digest of the value indication K(V2ᵢ) (hereinafter, digest D[K(V2ᵢ)]).

An auditing node (hereinafter concisely referred to as auditor) accessing the ledger 115 may ascertain the occurrence of an update of the field value Vᵢ (as indicated by the respective field identifier Iᵢ), and assess the consistency of the update by computing the digest of the value indication K(V2ᵢ) and verifying an equality thereof with the digest D[K(V2ᵢ)] appended to the ledger 115 (thus, more generally, an auditor accessing the ledger 115 may ascertain a consistency between the values or value indications stored in the value repository 110 and the data blocks appended to the ledger 115).

Hence, after a number of data storing and/or updating, the ledger 115 comprises a sequence of data blocks BLK_{q}.

According to an embodiment, each data block BLK_{q} may be associated with one or more fields. According to an embodiment, as better discussed in the following, each data block BLK_{q} may be associated with an update event of one or more fields: just as a practical example, the appended data block BLK_{Q} may be associated with an update event of the fields F_{N}, F_{N-1}, F_{N-2} (wherein the update event determines the update of the respective field values V_{N}, V_{N-1}, V_{N-2} to the values V1_{N}, V1_{N-1}, V1_{N-2}, respectively), and the appended data block BLK_{Q+1} may be associated with an update event of the field Fᵢ (wherein the update event determines the update of the respective field value Vᵢ from the value V1ᵢ to the value V2ᵢ).

Therefore, in the proposed solution, the ledger 115 represents, as a whole, a consistent history of the updates (changes) of the composite object over time (hereinafter, field update history). Indeed, the updates of the composite object comprise an append-only sequence containing the digests of the values (or, equivalently, of the value indications), thus preventing alternate values from being used in their place.

In the proposed solution, each value (or value indication) stored in the value repository 110 is a removable element that can be managed (e.g., stored and/or disclosed and/or destroyed) independently, without affecting none of the previously recorded changes thereof appended to the ledger 115. Thus, the proposed solution makes data removal very simple, as data removal from the value repository 110 merely prevents the removed data from being examined, without affecting (thanks to the digest/value indirection) the consistency of the field update history represented by the ledger 115.

This allows implementing, in a disclosure phase (discussed in the following), selective disclosure (e.g., to an auditor) of the value repository 110. Just as an example, as better discussed in the following, selective disclosure of the value repository 110 may comprise selectively removing, from the value repository 110, one or more data including one or more values associated with one or more field values (selective data removal), thereby obtaining a partialized version of the value repository 110 containing only disclosable values and/or values to be disclosed (hereinafter, selected values), and by providing the ledger 115 and the partialized version of the value repository 110 to the auditor (so as to allow the auditor to check a consistency of the (unremoved) disclosed values contained in the partialized version of the value repository 110). Just as another example, as better discussed in the following, selective disclosure of the value repository 110 may comprise exporting, from the value repository 110, one or more data including the selected values and the ledger 115 (so as to allow the auditor to check a consistency of the selected values).

The above advantages are achieved in a quite simple way, thereby involving a relatively low consumption of networking, computational and storage resources.

Without losing generality, selective data disclosure/removal allowed by the proposed solution may be useful in use-case scenarios in which access to one or more fields (and, particularly, to the respective value fields) has to be controlled by restricting it selectively (especially when one or more fields are subject to strict confidentiality requirements), or, equivalently, for selective data disclosure purposes (as detailed here below).

Let be considered the following example of a use-case scenario taking advantage of selective data disclosure/removal.

For internal use, an automotive company collects, in a ledger/value repository data structure, data about car sales, organized as a list of sales with customers information and car model. Then, in a second moment, the company decides to sell anonymized collected data to a data buyer.

First, thanks to selective data removal, the collected data may be anonymized by removing all personal information of the customers, while maintaining non-personal information (such as geographical region and year of the sale).

Then, thanks to selective data removal, the remaining data of the anonymized collected data (hereinafter, salable values) may be fully removed, and the data structure (including the ledger, and the value repository without the removed salable values) may be sent to the data buyer.

To assess the data, the data buyer may randomly choose a small selection of the removed salable values, and the automotive company may send them to the data buyer. The data buyer is able to cryptographically prove by himself that the received values are the only one that could fit in the previously selected positions of the ledger. Thanks to that, the data buyer is able to obtain a truly random and therefore unbiased subset of the real original data, and assess its value. After the assessment, the data buyer may decide to buy a percentage of the dataset, for example 50%, by randomly choosing a selection of the removed salable values, which then may be made available by the automotive company.

Let be considered the following example of another use-case scenario taking advantage of selective data disclosure/removal.

In this example, the selective removal is used to implement a network system where the data removal from a shared ledger can be automated.

A single ledger is shared, via replication, between nodes inside a network, and a node (hereinafter, requesting node) makes a request for data removal (hereinafter, removal request).

The requesting node may append a signed removal request to the ledger. Upon reception of the ledger update including the removal request, the nodes in the network decide a compliance of the removal request. In case of compliance, the requesting node may delete its own copy of the removable data, then it may append to the ledger a signed self-declaration of data removal.

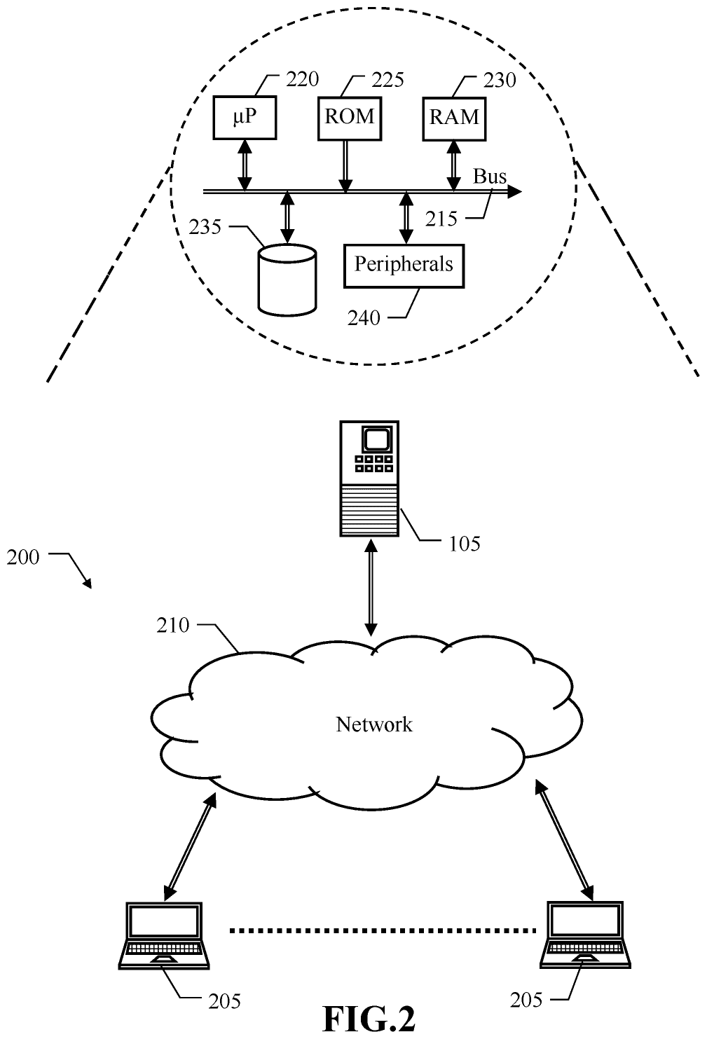

With reference now to FIG. 2, it shows, in terms of operating units, a schematic block diagram of an information technology infrastructure 200 (hereinafter concisely referred to as infrastructure) that may be used to implement the solution according to embodiments of the present disclosure.

According to an embodiment, the infrastructure 200 comprises the storage node 105 (or more thereof).

According to an embodiment, the infrastructure 200 comprises one or more (e.g., a plurality of) client nodes (for example, auditors) 205. According to an embodiment, each client node 205 is configured to access (or receive) the data structure stored in the storage node 105 and including the value repository 110 (e.g., a partialized version thereof as a result of selective data removal/disclosure allowed by the proposed solution) and the ledger 115. According to an embodiment, each client node 205 may be configured to allow checking the consistency between the values or value indications stored in the value repository 110 and the data blocks appended to the ledger 115).

According to an embodiment, the infrastructure 200 comprises a telecommunication network 210. According to an embodiment, the telecommunication network is configured to allow the storage node 105 and the client nodes 205 to communicate with each other. According to an embodiment, the telecommunication network 210 comprises a global telecommunication network based on the Internet. According to an embodiment, the telecommunication network 210 comprises a wired telecommunication network and/or a wireless communication network.

According to an embodiment, the storage node 105 and the client nodes 205 identify each one a respective computing system.

According to an embodiment, each computing system comprises a plurality of devices that are connected to each other through a bus structure 215 at one or more levels (with an architecture that is suitably scaled according to the type of the computing system).

According to an embodiment, each computing system comprises a microprocessor (μP) 220, or more thereof, providing a logic capability of the computing system.

According to an embodiment, each computing system comprises a non-volatile memory (ROM) 225 for storing basic code for a bootstrap of the computing system.

According to an embodiment, each computing system comprises a volatile memory (RAM) 230 used as a working memory by the microprocessor 220.

According to an embodiment, each computing system comprises a mass-memory 235 for storing programs and data. Just as an example, the mass-memory 235 may comprise storage devices of a data center wherein the storage node 105 is implemented. Just as another example, the mass-memory 235 may comprise a Solid-State Disk (SSD) for each client node 205.

According to an embodiment, each computing system comprises a number of controllers for peripherals, or Input/Output (I/O) devices, 240. Just as an example, the peripherals 240 of the storage node 105 may comprise a network adapter plugging them into the corresponding data center and then connecting it to a console of the data center for their control (for example, a personal computer, also provided with a drive for reading/writing removable storage devices, such as of USB type) and into a switch/router sub-system of the data center for communication with the telecommunication network 210. Just as another example, the peripherals 240 of each client node 205 may comprise a keyboard, a mouse, a monitor, a network adapter for connection to the telecommunication network 210 and a drive for reading/writing removable storage devices (such as of USB type).

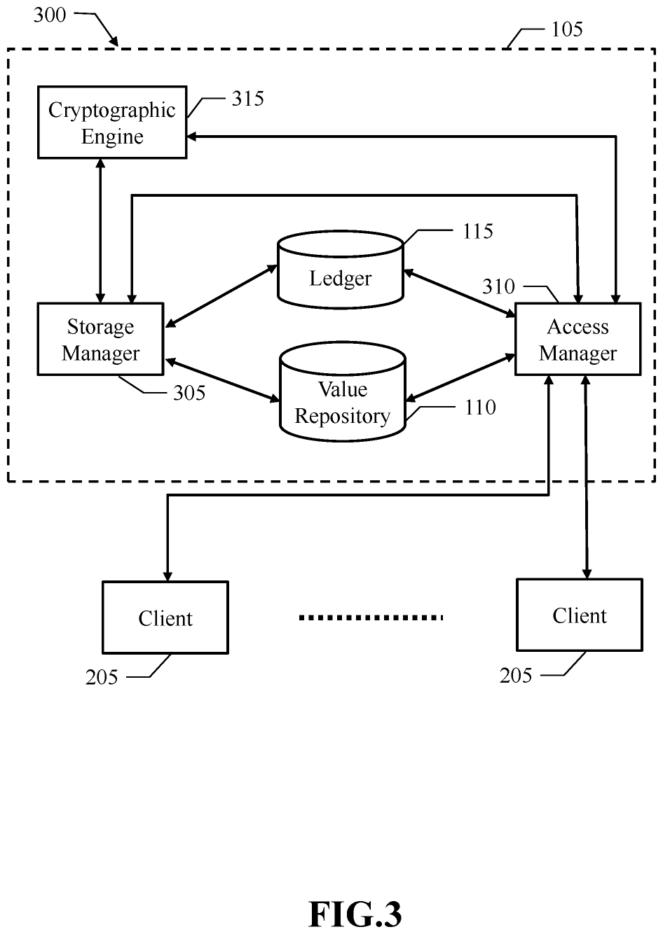

With reference now to FIG. 3, it shows the main software components that may be used to implement the solution according to embodiments of the present disclosure. Particularly, this figure shows the main software components 300 that may be used to implement the generic storage node 105 according to embodiments of the present disclosure. For the sake of completeness, this figure also shows the client nodes 205 interacting with the storage node 105.

According to an embodiment, the software components 300 are stored in the mass memory and loaded (at least partially) into the working memory of the storage node 105 when the programs are running, e.g. together with an operating system and other application programs not directly relevant to the solution according to embodiments of the present disclosure (thus omitted in the figure for the sake of simplicity). The programs are initially installed into the mass memory, for example, from removable storage devices or from the telecommunication network. In this respect, each program may be a module, segment or portion of code, which comprises one or more executable instructions for implementing the specified logical function.

According to an embodiment, the software components 300 of the storage node 105 comprise a storage manager 305 for managing data storing. According to an embodiment, the storage manager 305 is configured to manage the storing of the fields of the composite object in the value repository 110 and in the ledger 115.

According to an embodiment, the storage manager 305 reads/writes the value repository 110 storing the values (or value indications) of the value fields, and the ledger storing the identifiers and the digests of the values (or of the value indications).

According to an embodiment, the storage manager 305 may allow interaction of the storage node 105 with other storage nodes (not shown).

According to an embodiment, the software components 300 of the storage node 105 comprise an access manager 310. According to an embodiment, the access manager 310 manages the access (by the client nodes 205) to the data stored in the storage node 105. According to an embodiment, the access manager 310 selectively reads the value repository 110. According to an embodiment, the access manager 310 may selectively download values (or value indications) from the value repository 110 and send them, together with a copy of the ledger 115, to the (user/auditor) client nodes 205. According to an embodiment, the access manager 310 may selectively allow the client nodes 205 to access the ledger 115 and a partialized version of the value repository 110 resulting from selective data removal performed on the value repository 110 or on a copy thereof.

According to an embodiment, the software components 300 of the storage node 105 comprise a cryptographic engine 315 implementing cryptography operations. According to an embodiment, the cryptographic engine 315 is configured to compute the value indications (e.g., the encrypted values) and the respective digests.

According to an embodiment, the cryptographic engine 315 interacts with the storage manager 305 (e.g., so as to allow transmission (to the storage manager 305) of the value indications (e.g., the encrypted values) to be stored into the value repository 110 and the respective digests to be appended to the ledger 115).

According to an embodiment, the cryptographic engine 315 interacts with the access manager 310 (e.g., so as to provide the client nodes 205 with an accessible cryptographic tool allowing them to perform digest computations and/or decryption operations).

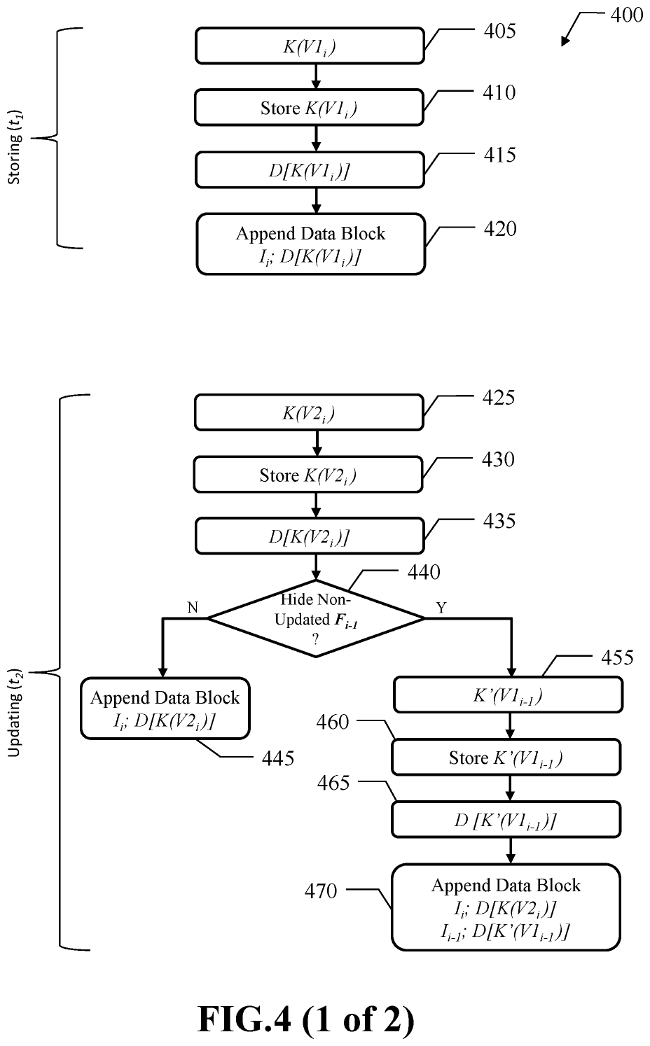

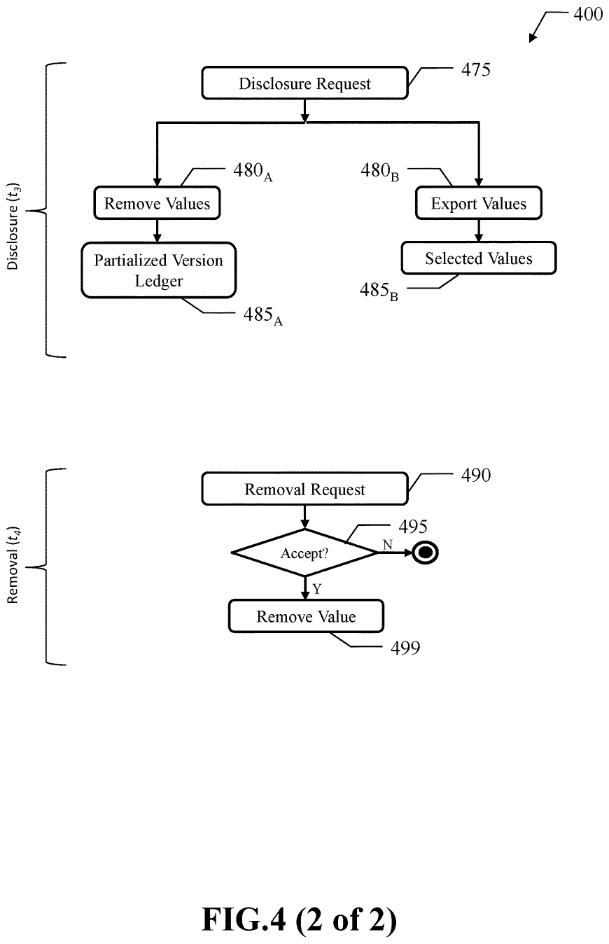

With reference now to FIG. 4, it shows an activity diagram which describes the flow of activities relating to an implementation of the solution according to embodiments of the present disclosure. Particularly, the activity diagram represents an exemplary process or method 400 that may be used to store, update, disclose and remove data in the form of one or more fields. More particularly, the activity diagram represents an exemplary (single) iteration of the process or method 400 that may be used to store (e.g., during a storing phase taking place at a time instant t₁) the i-th field Fᵢ (action steps 405-420), to update it (e.g., during an updating phase taking place at a time instant t₂ following the time instant t₁) from the value V1ᵢ to the value V2ᵢ (steps 425-470), to disclose it (e.g., during a disclosure phase, for example taking place at a time instant t₃ following the time instant t₂), and to remove it (e.g., during a removal phase, for example taking place at a time instant t₄ preceding or following the time instant t₂ and/or preceding or following the time instant t₃). In this respect, each step of the activity diagram may correspond to one or more executable instructions for implementing the specified logical function on the relevant software component of the storage node 105.

According to an embodiment, the method 400 comprises, during the storing phase, storing the field identifier Iᵢ and the value V1ᵢ of the field value Vᵢ of the i-th field Fᵢ (action steps 405-420).

According to an embodiment, said storing may arise in response to a corresponding command from a client, from an administrator of the storage node 105, and/or from a (local/remote) software application.

According to an embodiment, said storing comprises encrypting (with a proper encryption key) the value V1ᵢ thereby obtaining an encrypted value K(V1ᵢ) (action step 405). Although in this embodiment a value indication K(V1ᵢ) in the form of encrypted value K(V1ᵢ) is considered, this should not be construed limitatively. In the following, whenever the encrypted value K(V1ᵢ) is cited, it is intended that the associated feature and/or method step(s) equivalently apply in embodiments in which a value indication K(V1ᵢ) other than the encrypted value K(V1ᵢ) is considered.

According to an embodiment, the encryption key comprises a private key (or a derivative thereof) of a public key/private key pair associated with the ledger 115. According to an embodiment, the encryption key comprises an ephemeral private key univocally associated with the value V1ᵢ and generated from the private key (or master private key) of the public key/private key pair associated with the ledger 115. Just as an example, encryption by ephemeral private may be performed by using the sealed-box construction of cross-platform cryptography library Libsodium.

Encryption by means of an ephemeral key allows storing, for each field, different versions of a same value, each one resulting in a different digest. This allows defending against dictionary-based attacks, and allows obfuscating any eventual equality relation between values used in different parts of the composite object, that could otherwise put a limit to selective data removal. Moreover, as better discussed in the following, this allows hiding an implicit value preservation during an update event of a different field.

As should be understood, although explicit reference has been made ephemeral key encryption storing, for each field, different versions of a same value, this should not be construed limitatively. Indeed, other techniques, such as salted hashing, may be foreseen to achieve same or similar purposes.

According to an embodiment, encrypted value K(V1ᵢ) computation is performed by the cryptographic engine 315 of the storage node 105 (e.g., in response to a corresponding command from the storage manager 305 of the storage node 105).

According to an embodiment, said storing comprises storing the encrypted value K(V1ᵢ) in association with the field identifier Iᵢ in the value repository 110 (action step 410). According to an embodiment, the storing of the encrypted value K(V1ᵢ) in the value repository 110 is managed by the storage manager 305 of the storage node 105.

According to an embodiment, said storing comprises computing a digest of the encrypted value K(V1ᵢ) (i.e., the digest D[K(V1ᵢ)]) (action step 415).

According to an embodiment, digest D[K(V1ᵢ)]) computation is performed by the cryptographic engine 315 of the storage node 105 (e.g., in response to a corresponding command from the storage manager 305 of the storage node 105).

According to an embodiment, said storing comprises appending to the ledger 115 a data block comprising the field identifier Iᵢ and the digest D[K(V1ᵢ)] (action step 420).

According to an embodiment, data block appending is performed by the storage manager 305 of the storage node 105.

According to an embodiment, the method 400 comprises, during the updating phase, updating the field value Vᵢ of the i-th field Fᵢ from the value V1ᵢ to the value V2ᵢ (steps 425-470). According to an embodiment, the updating of the field value Vᵢ of the i-th field Fᵢ from the value V1ᵢ to the value V2ᵢ is performed in response to an updating request.

According to an embodiment, said updating may arise in response to a corresponding command from a client node, from an administrator of the storage node 105, and/or from a (local/remote) software application.

According to an embodiment, said updating is triggered by an update event of one or more of fields (the i-th field Fᵢ in the example at issue), and results in respective encrypted value storing and identifier/digest appending (discussed here below) which are referred only to the field(s) having triggered the update event. Therefore, as mentioned above, the ledger 115 represents, as a whole, a consistent field update history.

According to an embodiment, said updating comprises encrypting (with a proper encryption key) the value V2ᵢ thereby obtaining an encrypted value K(V2ᵢ) (action step 425). Although in this embodiment a value indication K(V2ᵢ) in the form of encrypted value K(V2ᵢ) is considered, this should not be construed limitatively. In the following, whenever the encrypted value K(V2ᵢ) is cited, it is intended that the associated feature and/or method step(s) equivalently apply in embodiments in which a value indication K(V2ᵢ) other than the encrypted value K(V2ᵢ) is considered.

According to an embodiment, the encryption key comprises a private key (or a derivative thereof) of a public key/private key pair associated with the ledger 115. According to an embodiment, the encryption key comprises an ephemeral private key univocally associated with the value V2ᵢ and generated from the private key (or master private key) of the public key/private key pair associated with the ledger 115 (with same advantages of ephemeral key encryption discussed above).

According to an embodiment, encrypted value K(V2ᵢ) computation is performed by the cryptographic engine 315 of the storage node 105 (e.g., in response to a corresponding command from the storage manager 305 of the storage node 105).

According to an embodiment, said updating comprises storing the encrypted value K(V2ᵢ) in association with the field identifier Iᵢ in the value repository 110 (action step 430). According to an embodiment, the storing of the encrypted value K(V2ᵢ) in the value repository 110 is managed by the storage manager 305 of the storage node 105.

According to an embodiment, said updating comprises computing a digest of the encrypted value K(V2ᵢ) (i.e., the digest D[K(V2ᵢ)]) (action step 435). According to an embodiment, digest D[K(V2ᵢ)]) computation is performed by the cryptographic engine 315 of the storage node 105 (e.g., in response to a corresponding command from the storage manager 305 of the storage node 105).

According to an embodiment, said updating comprises appending to the ledger 115 a data block comprising the field identifier Iᵢ and the digest D[K(V2ᵢ)] (action step 445). According to an embodiment, appending of the data block comprising the field identifier Iᵢ and the digest D[K(V2ᵢ)] practically decrees replacement of the value V1ᵢ of the field value Vᵢ, which thus represents or becomes an old or previous value of the field value Vᵢ.

According to an embodiment, data block appending is performed by the storage manager 305 of the storage node 105.

According to an embodiment, not shown, said updating may comprise deleting the encrypted value K(V1ᵢ) from the value repository 110 (or, more generally, deleting the old or previous value of the field value Vᵢ). For example, deletion of the encrypted value K(V1ᵢ) (or, more generally, of the old or previous value of the field value Vᵢ) may be advantageously provided for saving space in the value repository 110 in scenarios in which the knowledge of old or previous values is of no interest. For the purposes of the present disclosure, the deletion of the encrypted value K(V1ᵢ) (or, more generally, of the old or previous value of the field value Vᵢ) makes the encrypted value K(V1ᵢ) (or, more generally, the old or previous value of the field value Vᵢ) not accessible any longer, and hence not selectively disclosable during the disclosure phase. This does not affect (thanks to the digest/value indirection) a consistency of the field update history represented by the ledger 115.

According to an embodiment, as mentioned above, said updating may be triggered by an update event of one or more of fields (the i-th field Fᵢ in the example at issue), and results in encrypted value storing and identifier/digest appending only referred to the field(s) having triggered the update event. Therefore, in this embodiment, any field which has not triggered the update event (and, hence, which is not involved in the updating phase) represents a non-updated field for which a value preservation is implicitly disclosed or admitted.

According to an embodiment, said updating comprises hiding the value preservation of one or more non-updated fields other than the i-th field Fᵢ. In other words, in this embodiment, the method 400 comprises, contextually to said updating resulting from the update event triggered by the i-th field Fᵢ, hiding the fact that another field has not been updated.

Without losing generality, the non-updated fields (other than the i-th field Fᵢ) for which value preservation is desired or requested to be hidden, comprise one or more predetermined fields and/or one or more fields in a predetermined relationship with the i-th field Fᵢ, and/or one or more fields bound by confidentiality or privacy agreements.

Let be exemplary supposed, for the sake of description ease, that the non-updated fields for which value preservation is desired or requested to be hidden comprises the (i−1)-th field Fᵢ₋₁ (identified by the field identifier Iᵢ₋₁), and that the respective field value Vᵢ₋₁ is at the value V1ᵢ₋₁ since some point in the past before the time instant t₂. Let be also supposed that, consistently with the method steps discussed for the storing phase, the encrypted value K(V1ᵢ₋₁) (which is associated with the (i−1)-th field Fᵢ₋₁) was stored in the value repository 110 and that a data block comprising the field identifier Iᵢ₋₁ and a digest of the encrypted value K(V1ᵢ₋₁) (i.e., the digest D[K(V1ᵢ₋₁)]) was appended to the ledger 115. Let be also supposed that the encrypted value K(V1ᵢ₋₁) has been obtained by encrypting the value V1ᵢ₋₁ with a respective ephemeral private key.

According to an embodiment, if the value preservation of the field value Vᵢ₋₁ of the (i−1)-th field Fᵢ₋₁ has not to be hidden (exit branch N of decision step 440), action step 445 is performed (as discussed above) by appending to the ledger 115 the data block comprising (only) the field identifier Iᵢ and the digest D[K(V2ᵢ)]).

According to an embodiment, if the value preservation of the field value Vᵢ₋₁ of the (i−1)-th field Fᵢ₋₁ has to be hidden (exit branch Y of decision step 440), action steps 455-470 are performed which are aimed at appending to the ledger 115 a data block comprising both the field identifier Iᵢ with the associated digest D[K(V2ᵢ)], and the field identifier Iᵢ₋₁ with a digest (associated with the value V1ᵢ₋₁) different from the digest D[K(V1ᵢ₋₁)]).

According to an embodiment, if the value preservation of the field value Vᵢ₋₁ of the (i−1)-th field Fᵢ₋₁ has to be hidden (exit branch Y of decision step 440), said updating comprises encrypting the value V1ᵢ₋₁ with a different ephemeral private key generated from the master private key (action step 455), thereby obtaining, for the same value V1ᵢ₋₁, an encrypted value (hereinafter, encrypted value K′(V1ᵢ₋₁)) different from the encrypted value K(V1ᵢ₋₁), storing the encrypted value K′(V1ᵢ₋₁) in the value repository 110 (action step 460), computing a digest of the encrypted value K′(V1ᵢ₋₁) (i.e., the digest D[K′(V1ᵢ₋₁)], which is inherently different from the digest D[K(V1ᵢ₋₁)) (action step 465), and appending to the ledger 115 a data block comprising both the field identifier Iᵢ with the associated digest D[K(V2ᵢ)]), and the field identifier Iᵢ₋₁ with the associated (different) digest D[K′(V1ᵢ₋₁)]) (action step 470).

Since the digest D[K′(V1ᵢ₋₁)]) is different from the digest D[K(V1ᵢ₋₁)]), an auditor is not able to determine, without cryptographic computations, if the (i−1)-th field Fᵢ₋₁ has been actually updated.

In the exemplary considered embodiment, the hiding of the value preservation of one or more non-updated fields other than the i-th field Fᵢ is performed contextually to the updating resulting from the update event triggered by the i-th field Fᵢ. Broadly speaking, for each considered field, the hiding of the value preservation of the considered field may be performed contextually to the updating of a selected one of the fields different from the considered field.

Without losing generality, embodiments may be provided in which the hiding of the value preservation of one or more fields is triggered by a respective hiding event, which, depend on the specific use-case scenario, may be independent from the update events. Just as an example, the hiding event may take place periodically.

Let be considered, just as an example, a hiding event occurring at a time instant (hereinafter, intermediate time instant) before time instant t₁ (i.e., storing of the i-th field Fᵢ with the value V1ᵢ) and time instant t₂ (i.e., updating of the i-th field Fᵢ from the value V1ᵢ to the value V2ᵢ), which is aimed at hiding a non-update (at the intermediate time) of the i-th field Fᵢ with respect to the value V1ᵢ. In this example, the non-update hiding of the i-th field Fᵢ may be obtained by storing, in the value repository 110, a further (and different) encrypted value associated with the value V1ᵢ (the encrypted value K(V1ᵢ) associated with the value V1ᵢ, and the further encrypted value associated with the value V1ᵢ being for example obtained, as discussed above, by encrypting the value V1ᵢ with respective ephemeral private keys generated from a private master key), and appending to the ledger 115 a further data block comprising the field identifier Fᵢ and a digest of the further encrypted value.

Let be considered the following example of a use-case scenario taking advantage of non-update hiding.

A bank wants to maintain a checking account using the proposed solution, to achieve auditability at different levels, disclosing different data portions to different auditors.

Thanks to selective data disclosure, it is possible to select which removable values may be shown to a specific auditor. However, the digests of the removed values cannot be removed, thus exposing information about value change patterns. For example, it could be possible to detect from the digests when a change in the balance may have occurred. Additionally, if the hash function is known, it would be possible to check if the digest associated with each value is present in the ledger (for example, if the balance was equal to zero at any point of the history).

A wrapping of the removable values suitable to prevent exposing this kind of data comprises for example a salted hashing, or asymmetrical encryption using an ephemeral key. Additionally, the removable value relating to the balance can be re-written in the ledger at regular intervals, and thanks to this wrapping it is possible to use different salts or different ephemeral keys every time, generating a sequence of different digests independently of the actual value change pattern, thus practically obfuscating the value change pattern to any auditor that did not receive the removable values in its own selective disclosure.

According to an embodiment, the method 400 comprises, during the disclosure phase, receiving, by the auditor, a disclosure request for one or more values (hereinafter, requested values) of the field value of a requested field, or more thereof (action node 475).

According to an embodiment, the requested values may comprise a current value corresponding to a last updating of the field value, and/or one or more past (or old or previous) values corresponding to one or more updating of the field value before the last updating.

Back to the example of above in which, during the updating phase, updating of the i-th field Fᵢ from the value V1ᵢ to the value V2ᵢ has occurred, the value V2ᵢ represents the current value of the field value Vᵢ, and the value V1ᵢ represents one of the past (or old or previous) values of the field value Vᵢ.

According to an embodiment, the method 400 comprises, in response to the disclosure request, returning the requested values by selectively disclosing the value repository 110 to the auditor. According to an embodiment, the method 400 further comprises, in response to the disclosure request, returning both the requested values and the corresponding appended data block(s) to the auditor (for example, in case the ledger 115 is a private ledger with no or limited access to the auditor).

According to an embodiment, selective disclosure of the value repository 110 may comprise (e.g., depending on the disclosure request and/or on the use-case scenario) removal of values (or data) from the value repository 110 to obtain or generate a corresponding (disclosable) partialized version of the value repository 110 containing only the selected (requested) values (action step 480A), and providing the partialized version of the value repository 110 and the ledger 115 to the auditor (action node 485A). The removal of values from the value repository 110 merely prevents the removed values from being examined by the auditor, without affecting (thanks to the digest/value indirection) a consistency of the field update history represented by the ledger 115, and without affecting the possibility of allowing the auditor to check the consistency of the (unremoved) selected (requested) values. Back to the example of above in which, during the updating phase, updating of the i-th field Fᵢ from the value V1ᵢ to the value V2ᵢ has occurred, removal of values may comprise the removal of past or old or previous values of the field value Vᵢ (in this example, the value V1ᵢ or the corresponding indication K(V1ᵢ)) e.g., so as not to disclose unnecessary old versions of the field value Vᵢ.

According to an alternative embodiment, selective disclosure of the value repository 110 may comprise (e.g., depending on the disclosure request and/or on the use-case scenario) exporting the selected (requested) values from the value repository 110 (action node 480_{B}), and providing the selected (requested) values and the ledger 115 to the auditor (action node 485_{B}). The export of the selected (requested) values from the value repository 110 allow the auditor to examine only the selected (requested) values and to check the consistency thereof, without affecting (thanks to the digest/value indirection) the consistency of the field update history represented by the ledger 115. Back to the example of above in which, during the updating phase, updating of the i-th field Fᵢ from the value V1ᵢ to the value V2ᵢ has occurred, export of the selected (requested) values may comprise the export of the updated or current value of the field value Vᵢ (in this example, the value V2ᵢ or the corresponding indication K(V2ᵢ)) e.g., so as not to disclose unnecessary old or past versions of the field value Vᵢ.

According to an embodiment, the method 400 comprises, during the removal phase, in response to a removal request (action node 490) for removing, for at least one field value, the respective stored value(s), and in response to an acceptance of the removal request (exit branch Y of decision node 495), selectively removing the stored value from the value repository 110 (action node 499).

Just as an example, the stored value(s) to be removed may comprise personal or sensitive information of a user (for example, the user having performed the removal request, or the user on behalf of whom the removal request has been performed), e.g. so as to comply with the general data protection regulation (GDPR) of the European Union.

The removal of values from the value repository 110 prevents the removed values from being available to the storage node 105 (and, hence, to any other nodes or entities with which the storage node 105 may share the value repository 110, or part thereof).

According to an embodiment, removing the stored value from the value repository 110 may comprise assigning a null value (or other predefined value) to the respective field value. Additionally or alternatively, removing the stored value from the value repository 110 may comprise storing or attaching a document or a file to the respective field value, for example a document or a file attesting the removal request (preferably, together with a reason or justification or purpose for it).

### Modifications

Naturally, in order to satisfy local and specific requirements, a person skilled in the art may apply many logical and/or physical modifications and alterations to the present disclosure. More specifically, although this disclosure has been described with a certain degree of particularity with reference to one or more embodiments thereof, it should be understood that various omissions, substitutions and changes in the form and details as well as other embodiments are possible. Particularly, different embodiments of the present disclosure may be practiced even without the specific details (such as the numerical values) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any embodiment of the present disclosure may be incorporated in any other embodiment as a matter of general design choice. Moreover, items presented in a same group and different embodiments, examples or alternatives are not to be construed as de facto equivalent to each other (but they are separate and autonomous entities). In any case, each numerical value should be read as modified according to applicable tolerances; particularly, unless otherwise indicated, the terms “substantially”, “about”, “approximately” and the like should be understood as within 10%, preferably 5% and still more preferably 1%. Moreover, each range of numerical values should be intended as expressly specifying any possible number along the continuum within the range (comprising its end points). Ordinal or other qualifiers are merely used as labels to distinguish elements with the same name but do not by themselves connote any priority, precedence or order. The terms include, comprise, have, contain, involve and the like should be intended with an open, non-exhaustive meaning (i.e., not limited to the recited items), the terms based on, dependent on, according to, function of and the like should be intended as a non-exclusive relationship (i.e., with possible further variables involved), the term a/an should be intended as one or more items (unless expressly indicated otherwise), and the term means for (or any means-plus-function formulation) should be intended as any structure adapted or configured for carrying out the relevant function.

An aspect of the solution according to embodiments of the present disclosure provides a method for storing data. Without losing generality, the data may be of any type (for example, partial, different and additional data with respect to the ones mentioned above).

According to an embodiment, the data are stored in the form of one or more fields. Without losing generality, the fields may comprise any number and type of fields.

According to an embodiment, each field comprises a respective field identifier and a respective field value. Without losing generality, the field identifier may for example be an attribute or property or feature of the respective field, and the field value may for example be a textual value and/or numerical value, and/or a value among a plurality of accepted values. Without losing generality, each field may comprise one or more fixed components of the respective field, and/or one or more variable or updatable components of the respective field. Without losing generality, the field identifier may represent the fixed component of the respective field, and the field value may represent the variable component of the respective field. Alternatively, both the field identifier and the field value may represent variable components of the respective field.

According to an embodiment, the method comprises, for each one of said one or more fields, storing the field identifier and a first value of the field value by storing an indication of the first value in association with the field identifier in a non-persistent data structure, and appending a first data block to a persistent data structure. Without losing generality, the storing the field identifier and a first value of the field value may comprise any additional operation, down to none (for example, verifying a digital signature and/or or an authorization associated with the first value). Without losing generality, the indication of the first value may be obtained by any cryptographic mechanism, including (but not limited to) encryption and/or encapsulation and/or any proper data bundling method. Without losing generality, when both the field identifier and the field value represent the variable components of the respective field, the method may comprise storing a first value of the field identifier and a first value of the field value by storing an indication of the first value of the field identifier and an indication of the first value of the field value in the non-persistent data structure, and appending a corresponding first data block to the persistent data structure.

Without losing generality, the non-persistent data structure may be any conventional (e.g., non-DLT) storage entity, such as a conventional database. Without losing generality, the persistent data structure may be a conventional (e.g., DLT) ledger or other storage entity. Without losing generality, the non-persistent data structure and the persistent data structure may be physically located in a same storage node, in different storage nodes and/or in different storage entities.

According to an embodiment, the first data block comprises the field identifier and a digest of the indication of the first value. Without losing generality, the field identifier may also be omitted in the appending operation. Without losing generality, when both the field identifier and the field value represent the variable components of the respective field, the first data block may comprise one or more digests of the indication of the first value of the field identifier and of the indication of the first value of the field value. Without losing generality, the digest or digests of the indication or indications of the first value may be computed based on any proper cryptographic hash function or any other mathematical algorithm mapping data of an arbitrary size to a bit array of a fixed size.

According to an embodiment, the method comprises, for each one of said one or more fields, updating the field value by storing an indication of a second value in association with said field identifier in the non-persistent data structure, and appending a second data block to the persistent data structure. Without losing generality, when both the field identifier and the field value represent the variable components of the respective field, the updating the field identifier and the field value from the respective first value to a respective second value may comprise storing an indication of the second value of the field identifier and an indication of the second value of the field value in the non-persistent data structure, and appending a corresponding second data block to the persistent data structure.

Without losing generality, the updating of the field value from the first value to the second value may comprise any additional operation, down to none (for example, verifying a digital signature and/or or an authorization associated with the second value).

According to an embodiment, the second data block comprises the field identifier and a digest of the indication of the second value. Without losing generality, when both the field identifier and the field value represent the variable components of the respective field, the second data block may comprise one or more digests of the indication of the second value of the field identifier and of the indication of the second value of the field value. Without losing generality, the digest or digests of the indication or indications of the second value may be computed based on any proper cryptographic hash function or any other mathematical algorithm mapping data of an arbitrary size to a bit array of a fixed size.

Further embodiments provide additional advantageous features, which may however be omitted at all in basic implementations.

According to an embodiment, the method further comprises receiving, from an auditing node, a disclosure request for at least one value of the field value of said field (the field thus being the requested field), and returning, to the auditing node, the at least one value associated with the corresponding field identifier retrieved from the non-persistent data structure, whereby allowing the auditing node to verify the at least one value according to at least one corresponding appended data block in the persistent data structure. Without losing generality, the appended data block(s) corresponding to the at least one value of the disclosure request may be provided together with the at least one value (e.g., when a private persistent data structure, such as a private blockchain, is considered), or may be autonomously retrieved by the auditing node (e.g., when a public persistent data structure, such as a public blockchain, is considered, in that the auditing node may for example access the persistent data structure on its own).

According to an embodiment, the persistent data structure is a private persistent data structure. However, the principles of the present disclosure equivalently apply when a public persistent data structure (such as a public blockchain) is considered.

According to an embodiment, said returning further comprises providing said at least one corresponding appended data block to the auditing node. Without losing generality, provision, to the auditing node, of the appended data block(s) corresponding to the at least one value of the disclosure request may comprise providing the whole private persistent data structure (or a portion thereof).

According to an embodiment, for the requested field, the at least one value (of the disclosure request) comprises at least one of a current value corresponding to a last updating of the field value, and one or more past values corresponding to one or more updating of the field value before said last updating.

According to an embodiment, the non-persistent data structure is a private non-persistent data structure, for example a private database with restricted access and management rights.

According to an embodiment, said returning comprises selectively disclosing the non-persistent data structure by generating a partialized version of the non-persistent data structure by removing one or more first data from the non-persistent data structure, and providing the partialized version of the non-persistent data structure and the persistent data structure to the auditing node. Without losing generality, when a public persistent data structure (such as a public blockchain) is considered instead of a private persistent data structure, provision of the persistent data structure to the auditing node is not necessary (in that the auditing node may access the persistent data structure on its own).

According to an embodiment, said returning comprises selectively disclosing the non-persistent data structure by exporting one or more second data from the non-persistent data structure, and providing said one or more second data and the persistent data structure to the auditing node.

Without losing generality, this selective disclosure may take place independently from the updating phase.

According to an embodiment, said one or more first data comprise said indication of the first value (or, more generally, the indications of one or more past or old values). Without losing generality, depending on the disclosure request and/or on the use-case scenario, data removal may involve, additionally or alternatively to removal of the indication of the first value, one or more values (or indications thereof) associated with one or more field values of any field.

According to an embodiment, said one or more second data comprise said indication of the second value (or, more generally, the indication of the current value). Without losing generality, depending on the disclosure request and/or on the use-case scenario, data export may involve, additionally or alternatively to export of the indication of the second value, one or more values (or indications thereof) associated with one or more field values of any field.

According to an embodiment, the method further comprises, in response to a removal request for removing, for at least one field value, the respective stored value, and in response to an acceptance of the removal request, selectively removing the stored value of the at least one field value from the non-persistent data structure. Without losing generality, this selective removal may take place independently from the updating and/or disclosure phases.

According to an embodiment, said indication of the first value and said indication of the second value comprise an encrypted first value and an encrypted second value, respectively.

According to an embodiment, said updating further comprises removing the indication of the first value from the non-persistent data structure.

According to an embodiment, the method further comprises hiding a non-update of the field value with respect to the first value. Without losing generality, said hiding may be performed contextually to an update event associated with a different field, or at a periodic or aperiodic hiding event independent from any update event.

According to an embodiment, said hiding comprises storing a further indication of the first value in the non-persistent data structure, the further indication of the first value comprising a further encrypted first value, and appending a further data block to the persistent data structure, the further data block comprising the field identifier and a digest of the further indication of the first value.

According to an embodiment, the encrypted first value and the further encrypted first value are encrypted with respective ephemeral private keys generated from a private key of a public key/private key pair associated with the persistent data structure. Without losing generality, alternative techniques, other than encryption based on ephemeral private keys, may be foreseen to achieve same or similar purposes. Examples of alternative techniques include, but are not limited to, salted hashing.

According to an embodiment, for each one of said one or more fields, said hiding is performed contextually to said updating for a selected one of the one or more fields different from said field.

According to an embodiment, the further data block comprises the field identifier and the digest of the indication of the second value associated with said field, and the field identifier and the digest of the further indication of the first value associated with the selected field.

According to an embodiment, the method further comprises selectively disclosing the non-persistent data structure to an auditing node by selectively removing, from the non-persistent data structure, one or more values associated with one or more field values, thereby obtaining a partialized version of the non-persistent data structure, and by providing the persistent data structure and the partialized version of the non-persistent data structure to the auditing node.

According to an embodiment, the method further comprises selectively disclosing one or more values associated with one or more field values to an auditing node by selectively providing, to the auditing node, the one or more values associated with one or more field values stored in the non-persistent data structure, and by providing the persistent data structure to the auditing node.

Generally, similar considerations apply if the same solution is implemented with equivalent methods (by using similar steps with the same functions of more steps or portions thereof, removing some non-essential steps or adding further optional steps); moreover, the steps may be performed in a different order, concurrently or in an interleaved way (at least in part).

Another aspect of the solution according to embodiments of the present disclosure provides a computer program configured for causing a computing system (such as the storage node) to perform the method of above when the computer program is executed on the computing system.

Another aspect of the solution according to embodiments of the present disclosure provides a computer program product.

According to an embodiment, the computer program product comprises one or more computer readable storage media having program instructions collectively stored on the readable storage media, the program instructions readable by the computing system to cause the computing system to perform the same method.

Generally, each (software) program may be implemented as a stand-alone module, as a plug-in for a pre-existing software program (for example, a storage manager and a storage client, respectively), or even directly in the latter. It would be readily apparent that it is also possible to deploy the same solution as a service that is accessed through a network (such as in the Internet). Similar considerations apply if the program is structured in a different way, or if additional modules or functions are provided; likewise, the memory structures may be of other types, or may be replaced with equivalent entities (not necessarily consisting of physical storage media). The program may take any form suitable to be used by any computing system, thereby configuring the computing system to perform the desired operations; particularly, the program may be in the form of external or resident software, firmware, or microcode (either in object code or in source code), for example, to be compiled or interpreted. Moreover, it is possible to provide the program on any computer readable storage medium. The storage medium is any tangible medium (different from transitory signals per se) that may retain and store instructions for use by the computing system. For example, the storage medium may be of the electronic, magnetic, optical, electromagnetic, infrared, or semiconductor type; examples of such storage medium are fixed disks (where the program may be pre-loaded), removable disks, memory keys (for example, USB), and the like. The program may be downloaded to the computing system from the storage medium or via a network (for example, the Internet, a wide area network and/or a local area network comprising transmission cables, optical fibers, wireless connections, network devices); one or more network adapters in the computing system receive the program from the network and forward it for storage into one or more storage devices of the computing system. In any case, the solution according to embodiments of the present disclosure lends itself to be implemented even with a hardware structure (for example, by electronic circuits integrated on one or more chips of semiconductor material), or with a combination of software and hardware suitably programmed or otherwise configured.

An embodiment provides a computing system (such as a storage node) comprising means configured for performing the steps of the method of above.

According to an embodiment, the computing system (such as the storage node) comprises a circuitry (i.e., any hardware suitably configured, for example, by software) for performing each step of the same method. Without losing generality, the computing system may be of any type (for example, implemented by a physical machine, a virtual machine, a cloud service and so on).

Another aspect of the solution according to embodiments of the present disclosure provides a system for storing data comprising a plurality of said computing systems.

Without losing generality, the system may have a different architecture (for example, based on a global, local or wide area network, exploiting any type of wired and/or wireless connections, such as of metal wire, optical fiber, Wi-fi, mobile telephone or satellite type, and so on). However, its implementation by virtual machines running on a same physical machine is not excluded.

Generally, similar considerations apply if the computing system and the whole system each has a different structure, comprises equivalent components or it has other operative characteristics. In any case, every component thereof may be separated into more elements, or two or more components may be combined together into a single element; moreover, each component may be replicated to support the execution of the corresponding operations in parallel. Moreover, unless specified otherwise, any interaction between different components generally does not need to be continuous, and it may be either direct or indirect through one or more intermediaries.

1. A method for storing data in the form of one or more fields each one comprising a respective field identifier and a respective field value, the method comprising, for each one of said one or more fields:
storing the field identifier and a first value of the field value by:
storing an indication of the first value in association with the field identifier in a non-persistent data structure, and
appending a first data block to a persistent data structure, the first data block comprising the field identifier and a digest of the indication of the first value, and
updating the field value by:
storing an indication of a second value in association with said field identifier in the non-persistent data structure, and
appending a second data block to the persistent data structure, the second data block comprising the field identifier and a digest of the indication of the second value.

2. The method according to claim 1, further comprising:
receiving, from an auditing node, a disclosure request for at least one value of the field value of said field, and
returning, to the auditing node, the at least one value associated with the corresponding field identifier retrieved from the non-persistent data structure, whereby allowing the auditing node to verify the at least one value according to at least one corresponding appended data block in the persistent data structure.

3. The method according to claim 2, wherein the persistent data structure is a private persistent data structure, said returning further comprising providing said at least one corresponding appended data block to the auditing node.

4. The method according to claim 2, wherein the at least one value comprises at least one of:
a current value corresponding to a last updating of the field value, and
one or more past values corresponding to one or more updating of the field value before said last updating.

5. The method according to claim 2, wherein the non-persistent data structure is a private non-persistent data structure, said returning comprising selectively disclosing the non-persistent data structure by:
generating a partialized version of the non-persistent data structure by removing one or more first data from the non-persistent data structure, and providing the partialized version of the non-persistent data structure and the persistent data structure to the auditing node; or
exporting one or more second data from the non-persistent data structure, and providing said one or more second data and the persistent data structure to the auditing node.

6. The method according to claim 5, wherein said one or more first data comprises said indication of the first value, and said one or more second data comprises said indication of the second value.

7. The method according to claim 1, further comprising, in response to a removal request for removing, for at least one field value, the respective stored value, and in response to an acceptance of the removal request, selectively removing the stored value of the at least one field value from the non-persistent data structure.

8. The method according to claim 1, wherein said indication of the first value and said indication of the second value comprise an encrypted first value and an encrypted second value, respectively.

9. The method according to claim 8, further comprising hiding a non-update of the field value with respect to the first value by:
storing a further indication of the first value in the non-persistent data structure, the further indication of the first value comprising a further encrypted first value, and
appending a further data block to the persistent data structure, the further data block comprising the field identifier and a digest of the further indication of the first value,
the encrypted first value and the further encrypted first value being encrypted with respective ephemeral private keys generated from a private key of a public key/private key pair associated with the persistent data structure.

10. The method according to claim 9, wherein, for each one of said one or more fields, said hiding is performed contextually to said updating for a selected one of the one or more fields different from said field.

11. The method according to claim 10, wherein the further data block comprises:
the field identifier and the digest of the indication of the second value associated with said field, and
the field identifier and the digest of the further indication of the first value associated with the selected field.

12. (canceled)

13. A software program product comprising one or more computer readable storage media having program instructions collectively stored on the readable storage media, the program instructions being readable by a computing system to cause the computing system to perform the method according to claim 1.

14. A computing system comprising circuitry configured for performing the method according to claim 1.

15. (canceled)
